(19) United States
(12) Patent Application Publication
(10) Pub. No.: US 2008/0195064 A1
(43) Pub. Date: Aug. 14, 2008

(54) Vaccine Spraying Apparatus for Newborn Chicks

(76) Inventors: Rafael S. Correa, Salisbury, MD (US); Mark Anthony Dekich, Salisbury, MD (US); Erich Frederick Bevensee, Eden, MD (US); William Douglas Samson, Salisbury, MD (US)

Correspondence Address: JACOBSON HOLMAN PLLC, 400 SEVENTH STREET N.W., SUITE 600, WASHINGTON, DC, 20004, US

(21) Appl. No.: 11/794,963

(22) PCT Filed: Jan. 26, 2006
(86) PCT No.: PCT/US06/02691

§ 371 Date: Feb. 8, 2008

Related U.S. Application Data
(60) Provisional application No. 60/646,618, filed on Jan. 26, 2005.

(51) Int. Cl. A61D 7/00; A01K 29/00

(52) U.S. Cl. 604/289; 119/665

(57) ABSTRACT

A vaccine spraying apparatus for vaccinating day-old chicks that includes a vaccine container with an agitation mechanism for mixing vaccine and diluent through controlled agitation. Vaccine is drawn from the container by a volumetric pump and dispensed through a plurality of spray nozzles mounted over a conveyor. Chicks contained in trays are moved along the conveyor to pass under the spray nozzles. The volume and orientation of the vaccine spray is controlled by a digital micro-control unit receiving data from a tracking device adjacent the conveyor that senses the position and speed of the trays.

This application is entitled to and hereby claims the priority of co-pending U.S. provisional application Ser. No. 60/646,618 filed Jan. 26, 2005.

### BACKGROUND OF THE INVENTION

1. Field of the Invention

The present invention is related to the poultry industry and, more particularly, to an apparatus for spraying vaccine on day-old chicks.

2. Description of the Related Art

The poultry industry is required to vaccinate day-old chicks prior to placing them in the field. Typical vaccines applied include Coccidiosis vaccine, Newcastle vaccine, Infectious Bronchitis vaccine and other respiratory virus vaccines, including I.B.D. and REO vaccines. A chick counter places day-old chicks in open trays, generally in lots of one hundred, after which the desired vaccines are applied in spray form over the trays as they are moved along a conveyor.

The vaccines present varying application requirements. Coccidiosis vaccine must be applied (sprayed) with a droplet size of approximately 100 to 400 microns. The large droplets lay on top of the chick's down and, because of the color and brightness of the diluent, the chicks are attracted to it and they drink it from each other's backs. As they ingest the oocyst, the desired coverage of the digestive tract is obtained.

Respiratory vaccines require a smaller droplet size, generally from 70 to 200 microns. The pulverization or misting of the vaccine allows the chick to inhale the vaccine through the normal breathing process as well as through penetration of the tear ducts (lachrymal) and from there to the respiratory system.

All application equipment available on the market today consists of a centrifugal mixing platform (laboratory stirring device) and a vaccine container that feeds a syringe to measure dosage. The syringe is activated by a pneumatic cylinder that loads and delivers a set volume of vaccine. The pressurized syringe feeds two or more spray nozzles with vaccine to produce the spray pattern and proper droplet size. The above-mentioned operations are triggered by a sensor or micro-switch that is activated when a tray of chicks, traveling in the conveyor, passes under the spray application equipment.

There are many problems associated with these prior art spraying techniques, beginning with the vaccine mixing procedures. In the centrifugal method, mixing is done by placing a container of diluent and vaccine concentrate over a laboratory magnetic stirring bar surface. By placing a magnet inside the vaccine container, the turning bar transmits the motion to the magnet inside the vaccine container, producing a stirring motion.

A laboratory magnetic stirring bar has a readily accessible variable stirring speed control. If the speed is too high, a vortex is formed and the differential in weight of the molecules actually causes them to separate. This separation is not apparent to the operator as the vaccine cells are not visible to the naked eye. Conversely, if the stirring speed is too slow, cells become concentrated on the bottom of the container, an unwanted result which is again invisible to the operator.

Mixing is also complicated by the fact that improper placement of the container negatively impacts stirring effectiveness, yet there is no fixed position at which the vaccine container is to be placed over the laboratory magnetic bar stirring surface. The uneven mixing conditions which often result from improper placement over the magnetic bar can cause viral or parasitic concentration in the vaccine container, further causing inconsistent application of vaccines due to inadequate vaccine suspension in the diluent. As a result, all chicks may be coated with diluent, but not necessarily with the right amount of vaccine virus or parasitic cells, thus affecting the vaccine efficacy.

Dosage control using conventional syringe technology with a pneumatic piston also presents problems. Although a syringe provides accurate dosage measurement, it is not designed to deliver its volume with consistent pressure. This is problematic in that droplet size is controlled by the orifice size and shape and constant pressure.

The pneumatic piston that activates the syringe moves forward with low pressure until it encounters resistance, as from the spray nozzles, and then builds up pressure to overcome the resistance. This condition causes the spray nozzles to squirt, dripping at the beginning and the end of the process, and makes it impossible to control droplet size over the plurality of chicks.

Further problems are introduced by the conventional spray nozzles that are used. The diameter and shape of the spray nozzle's orifice are responsible for the droplet size and area coverage (pattern). The shape and diameter of the spray is affected by mineral/calcium buildup in the orifice. As the orifice is reduced by such buildup, the time needed to deliver the necessary vaccine volume is increased. As there is no consideration for conveyor speed, part of the measured volume of vaccine is thus delivered outside the chick tray. The smaller diameter of the nozzles also affects the droplet size.

Since there is no time-controlled linkage between the syringe and the conveyor, the volume of vaccine per chick is not controllable. Some of the syringe contents are emptied after the chick tray on the conveyor has passed by, such that the vaccine is sprayed on the conveyor or the floor. Operators typically walk through puddles of vaccine, potentially carrying live vaccine all over the hatchery environment. This is a biohazard. If the operator or supervisor notices the condition, they typically solve the problem by unclogging the spray nozzle with the first sharp object they can find (pocket knife, paper clip, etc.), thereby altering the diameter and shape of the nozzle orifice. The resulting increase in nozzle orifice diameter affects droplet size and volume, causing the syringe to be emptied before the chick tray has completely passed under the spray, over-spraying some of the chicks and not spraying others.

Finally, conveyor speed adjustment difficulties are insufficiently addressed by conventional tray sensors or micro-switches. There are many variables during the vaccine spray application. Conveyor speed variation can cause the syringe to be emptied prematurely or belatedly. Conveyor back up or stoppage in the middle of a tray can cause the syringe to be emptied, soaking a few chicks and not vaccinating others. The on/off condition produced by conventional sensors or micro-switches, activated by the passing chick tray on a moving conveyor, is not sufficient to control the delivery of the vaccine.

All of the foregoing inconsistencies have an adverse effect on the vaccination process.

### SUMMARY OF THE INVENTION

In view of the foregoing, one object of the present invention is to overcome the difficulties of distributing properly mixed vaccine over all the chicks being conveyed in trays along a conveyor belt through a controlled volume, low pressure vaccine spraying apparatus that implements dosage control and pattern design control, independently of and unaffected by droplet size control.

Another object of the present invention is to provide an improved mixing apparatus that ensures the even suspension of vaccine cells throughout the diluent.

A further object of the present invention is to provide a vaccine spraying apparatus that produces a spray with no mechanical stress on the vaccine and without exposing the vaccine to high pressure.

A still further object of the present invention is to provide a vaccine spraying apparatus using an electronic pulse-activated volumetric pump to measure and dispense vaccine.

Yet another object of the present invention is to provide a vaccine spraying apparatus having a tracking device for sensing the position and speed of a passing tray on a conveyor, and for providing this data to a micro-control unit that adjusts the pace of the volumetric pump accordingly.

A still further object of the present invention is to provide a vaccine spraying apparatus having a programmable microprocessor able to compensate for uneven chick tray loading.

Another object of the present invention is to provide a microprocessor-controlled vaccine spraying apparatus that works cooperatively with an improved mixing apparatus relying on vaccine agitation.

Yet another object of the present invention is to provide a vaccine spraying apparatus that includes self-cleaning spray nozzles and dosage pattern programming capability.

Yet a further object of the present invention is to provide the software and hardware tools needed to implement custom design capability to apply various spray patterns and volumes using an automated vaccine spraying apparatus.

A still further object of the invention is to provide a vaccine spraying apparatus that is not complex in structure and which can be manufactured at low cost but yet used to efficiently vaccinate trays of day-old chicks with consistent and uniform vaccine coverage.

In accordance with these and other objects, the present invention is directed to a vaccine spraying apparatus for vaccinating day-old chicks. The apparatus includes a vaccine container for thoroughly mixing vaccine and diluent through controlled agitation, and a vaccine spraying station for cooperation with an existing moving conveyor. The vaccine container is coupled to a pulse-activated volumetric pump in the spraying station that draws vaccine from the container for dispensing the mixed vaccine through a hose coupled to the plurality of spray nozzles. The spray nozzles are mounted over the conveyor and direct the mixed vaccine onto a plurality of chicks passing in trays along the conveyor. A tracking device on the spraying station, mounted to be adjacent the conveyor, senses the position and speed of the trays, and conveys this information to a digital micro-control unit. The micro-control unit in turn directs the volumetric pump to dispense the vaccine in a volume appropriate for the detected tray speed and position.

These together with other objects and advantages which will become subsequently apparent reside in the details of construction and operation as more fully hereinafter described, reference being had to the accompanying drawings forming a part hereof, wherein like numerals refer to like parts throughout.

### BRIEF DESCRIPTION OF THE DRAWINGS

FIG. 1 illustrates a vaccine spraying apparatus in accordance with the present invention.

FIG. 2 is a block diagram of the components of the digital control system for the vaccine spraying apparatus of FIG. 1.

FIG. 3 is a perspective view of the spraying station of FIG. 1.

FIG. 4 is a side view of the spraying station of FIG. 3.

FIG. 5 is an end view of the spraying station of FIG. 3.

FIG. 6 is a conceptual view of the tracking and vaccine pumping subsystem in accordance with the present invention.

FIG. 7 is a circuit diagram of the memory chip of FIG. 2.

FIG. 8 is a circuit diagram of the memory chip of FIG. 7 attached to a programming dock of the digital control system of FIG. 2.

FIG. 9 is a logic diagram of the tracking and vaccine pumping subsystem of FIG. 6.

FIG. 10 is a representative screen view of pattern design software suitable for use in programming the memory chip of FIGS. 2 and 7.

FIG. 11 is a perspective view of the vaccine container and agitation mechanism of FIG. 1.

FIG. 12 is another perspective view of the vaccine container and agitation mechanism of FIG. 1.

FIG. 13 is a side view of the vaccine container and agitation mechanism of FIG. 1.

FIG. 14 is another side view of the vaccine container and agitation mechanism of FIG. 1.

FIG. 15 is another perspective view of the vaccine container and agitation mechanism of FIG. 1.

FIG. 16 is an exploded view of the components of the agitation assembly of the vaccine agitation mechanism of FIG. 11.

FIG. 17 is an assembled view of the components of the agitation assembly of the vaccine agitation mechanism of FIG. 16.

FIG. 18 is a bottom view taken along line 18-18 of FIG. 17.

FIG. 19 is a top view taken along line 19-19 of FIG. 17.

FIG. 20 is a cross-sectional view of the assembled agitation assembly of FIG. 17.

FIG. 21 is an exploded view of the components of the lid assembly of the vaccine container and agitation mechanism of FIG. 11.

FIG. 22 is an assembled view of the components of the lid assembly of FIG. 21.

FIG. 23 is a top view of the lid assembly of FIG. 22.

FIG. 24 is a side view of the lid assembly taken along along 24-24 of FIG. 23.

FIG. 25 is a side view of the lid assembly taken along along 25-25 of FIG. 23.

FIG. 26 is a bottom view of the lid assembly of FIG. 22.

FIG. 27 illustrates another embodiment of the support framework for a vaccine spraying apparatus in accordance with the present invention.

FIG. 28 is a side view of the vaccine spraying apparatus of FIG. 27.

FIG. 29 is a perspective view of the vaccine spraying apparatus of FIG. 27.

FIG. 30 is another perspective view of the vaccine spraying apparatus of FIG. 27.

### DETAILED DESCRIPTION OF THE PREFERRED EMBODIMENTS

Although only two preferred embodiments of the invention are explained in detail, it is to be understood that these embodiments are given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

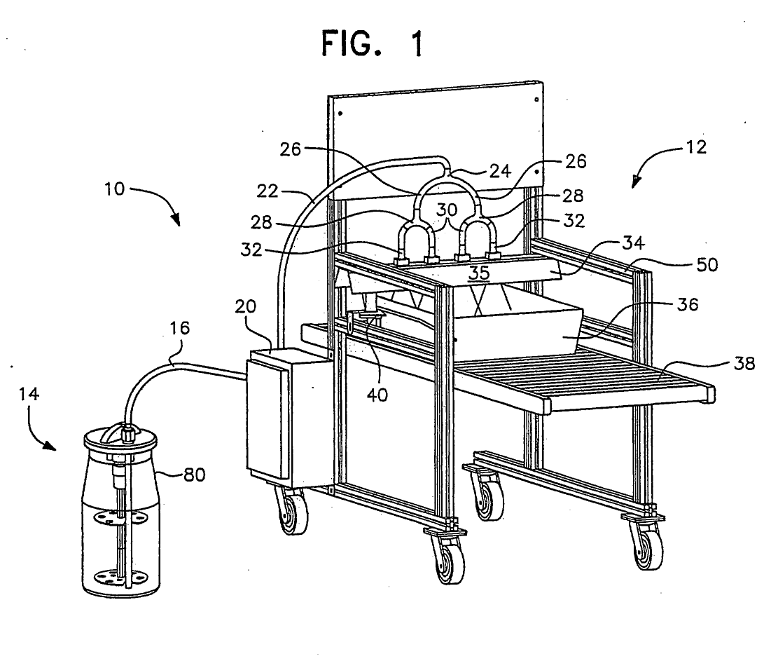

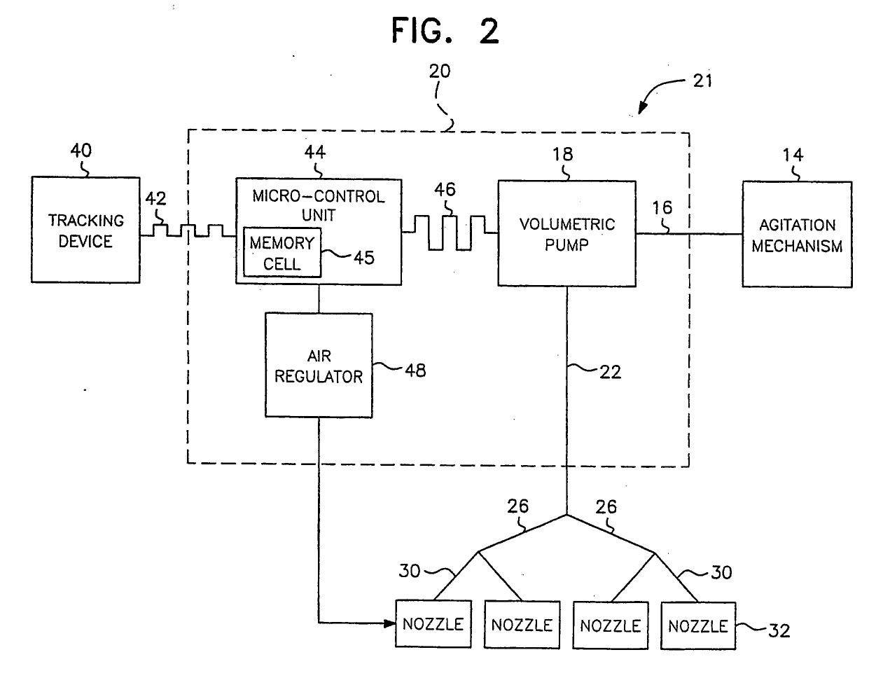

As shown in FIG. 1, the present invention is directed to a vaccine spray apparatus generally designated by the reference numeral 10. The apparatus 10 includes a spraying station generally designated by the reference numeral 12, a vaccine container 80, and a vaccine agitation mechanism generally designated by the reference numeral 14. The vaccine container and agitation mechanism 14 with associated power source 15 is coupled to the station 12 by a hose 16 which draws vaccine from the agitation mechanism 14 through the action of a pulse-activated volumetric pump 18 contained within a control box 20 as part of a digital control system generally designated by the reference numeral 21, as depicted in FIG. 2. The pump 18 is used to measure and dispense the vaccine through a supply hose 22. The supply hose 22 is split, such as by a first Y connector 24, into two sub-lines 26. Each of the sub-lines 26 is further split by second Y connectors 28 into two more sub-lines 30. Each sub-line 30 is coupled to a corresponding nozzle 32 in the station 12 for use in spray application of the vaccine. Other connecting components suitable for conveying fluids may be used in place of the hoses as would be understood by persons of ordinary skill in the art.

As shown in FIG. 1, the nozzles are mounted in a spray alignment system 34 and direct the vaccine spray downward toward a tray 36 moving on a conveyor segment 38. The conveyor segment 38 as shown is just a portion of a larger conveyor mechanism with which the spraying station is designed to operate. The overall conveyor mechanism is not shown but is driven and operated in accordance with conventional conveyor technology as would be known by persons of skill in the art. For purposes of description herein, the term “conveyor” is intended to include the particular segment 38 with which the spray station cooperates in the manner shown by FIGS. 1 and 3.

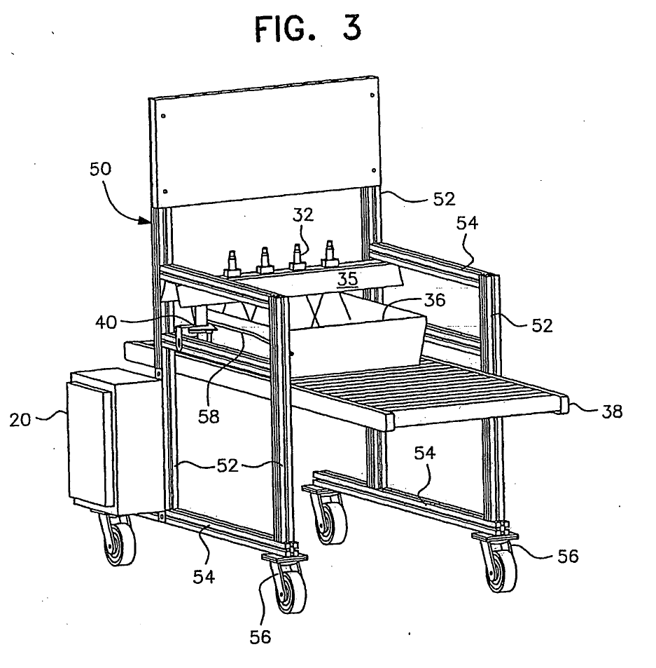

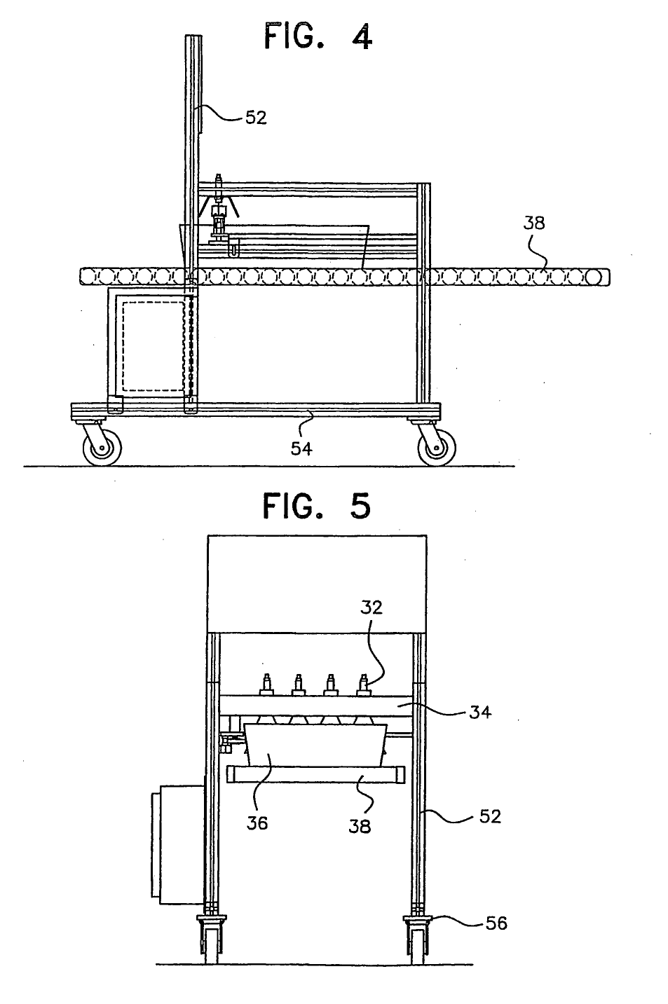

As shown without hoses in FIGS. 3-5, the spraying station 12 of the vaccine spray apparatus 10 is equipped with four self-cleaning spray nozzles 32. The nozzles 32 are located at approximately eight inches above the chicks (not shown), allowing for more vaccine to be placed on or over the chicks. These spray nozzles 32 are preferably equipped with push buttons for manual, automated and/or programmable self-cleaning.

The droplet size is controlled by air pressure supplied by a programmable air regulator 48. Unlike the prior art methods which pressurize the vaccine against a small orifice, creating mechanical stress on the vaccine and resulting in the squirting and dripping as described in the foregoing discussion of the related art, according to the present invention the air stream mixes with the vaccine externally, i.e., outside the nozzle, to form the droplet size and spray pattern. This type of spray technology is well known in the paint industry.

More particularly with respect to the present invention, the vaccine flows through the nozzle openings as a stream having a generally laminar flow under pressure on the order of 2-6 psi. Two low pressure air streams for each nozzle, which face each other and are located below the respective nozzle opening, break the vaccine stream to form the desired droplet size and pattern. One way to accomplish the desired flow of air to each nozzle is through the use of a pair of conduits 33 running longitudinally along the length of the hood 35 of the spray alignment system 34, one on either side thereof. Through appropriate aligned placement of apertures in the two conduits 33, air is directed to each of the nozzles from the opposing sides of the hood 35 to achieve the controlled dispersion of the vaccine streams exiting the nozzles.

The station 12 is built upon a frame generally designated by the reference numeral 50. The frame has spaced vertical side members 52 with adjoining horizontal members 54. The spacing between the side members 52 is determined by the width of the conveyor 38 as shown in FIGS. 1 and 3, with the spray alignment system 34 also extending transversely from one side member 52 to the other. More specifically, the frame 50 is constructed to associate and cooperate with a particular conveyor, as needed. The spraying station 12 can thus be adapted to accommodate conveyors of different sizes and types through frame construction.

The side frame members 52 are preferably supported by wheeled castors 56 for ease of mobility of the spray station 12, allowing for movement of the station along the conveyor beyond the segment 38 that is shown, if necessary. Movement of the tray 36 along the conveyor 38 is guided by basket guide elements 58.

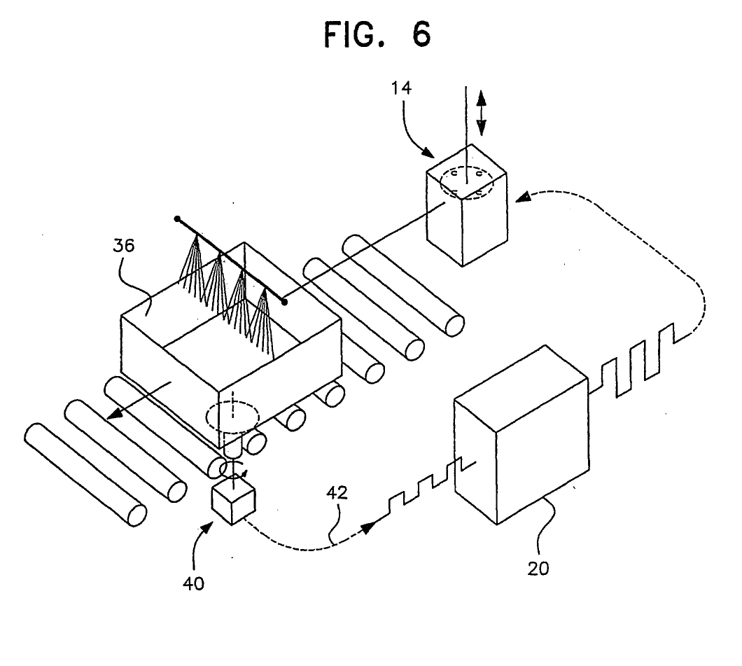

As shown in the block diagram of FIG. 2 and conceptually in FIG. 6, the spraying station 12 includes a tracking device 40 that senses the presence and movement/speed of the tray 36 on the conveyor 38. The tracking device 40, which may be embodied as an encoder or other comparable device as would be known by persons of skill in the art, sends signals 42 by means of electrical pulses to a digital micro-control unit 44 contained within the control box 20.

The micro-control unit 44 receives the electrical impulses 42 and converts them into the speed/location of the chick tray 36. In turn, the micro-control unit 44 feeds the impulse-activated volumetric pump 18 with the electrical impulses 46 that govern the volumetric pump 18. With this information, the pump measures and dispenses vaccine in an appropriate volume relative to the position and/or speed of the tray 36.

The micro-control unit or microprocessor 44 can be programmed to compensate for chick tray loading. For example, some chick counters load the chick tray 36 with the plurality of chicks to the front or the rear of the tray. Through programmed compensation, the proper amount of vaccine is directed to the appropriate locations.

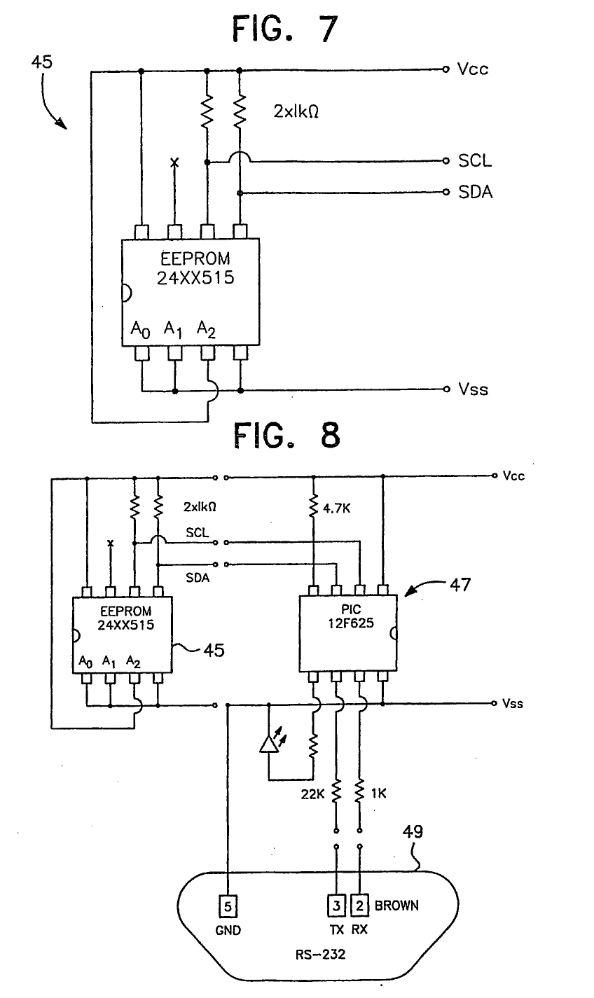

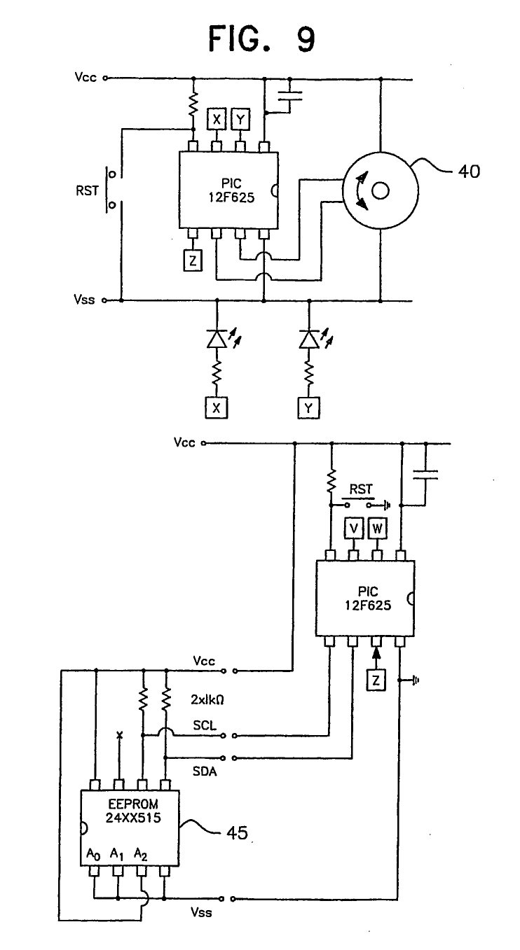

The programming is typically contained within a pre-programmed memory card or memory chip 45 as shown in FIG. 7. The chip is attached to a programming dock 47 connected to PC connection 49, as shown in FIG. 8. However, the present invention is not limited to the depicted implementation as other memory chip configurations and manners of connection may also be employed as would by persons of ordinary skill in the art. According to the present invention, different chips can be programmed with different spray patterns. Through plugging in of the appropriate chip for a given chick loading scenario, the digital control system 21 is able to apply a custom-designed dosage pattern throughout the entire length of the chick tray, independent of the speed of the tray on the conveyor while, at the same time, maintaining the overall volume of vaccine. The logic of the subsystem formed by the encoder 40 and the volumetric pump 18 as described herein and incorporating the memory chip 45 is depicted in FIG. 9. The spray pattern embodied within a particular memory chip 45 can be custom designed using software such as a WINDOWS type application for pattern design, a representative screen view of which is shown in FIG. 10.

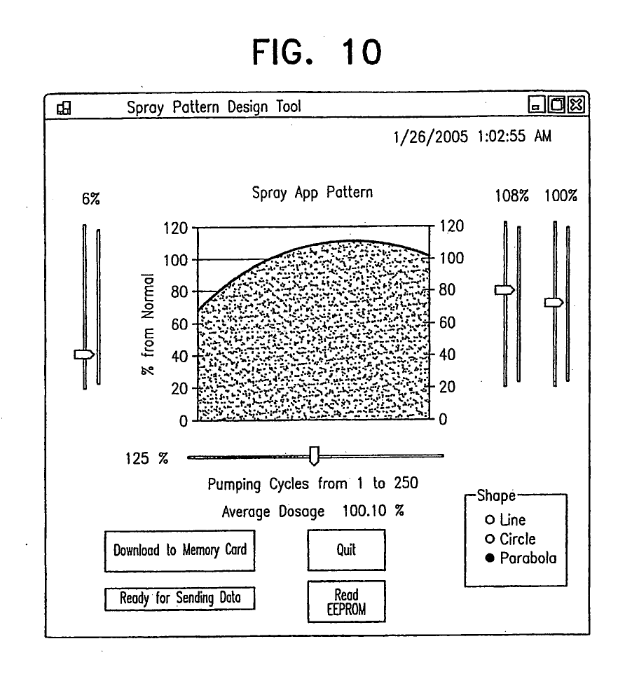

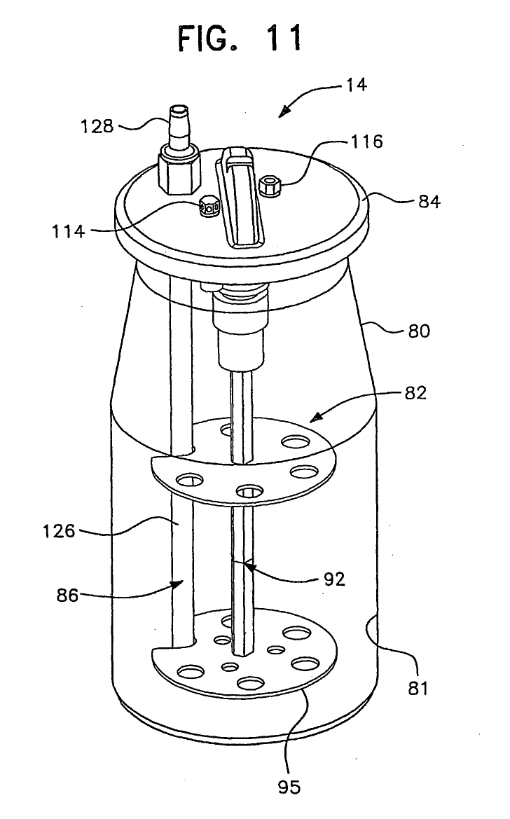

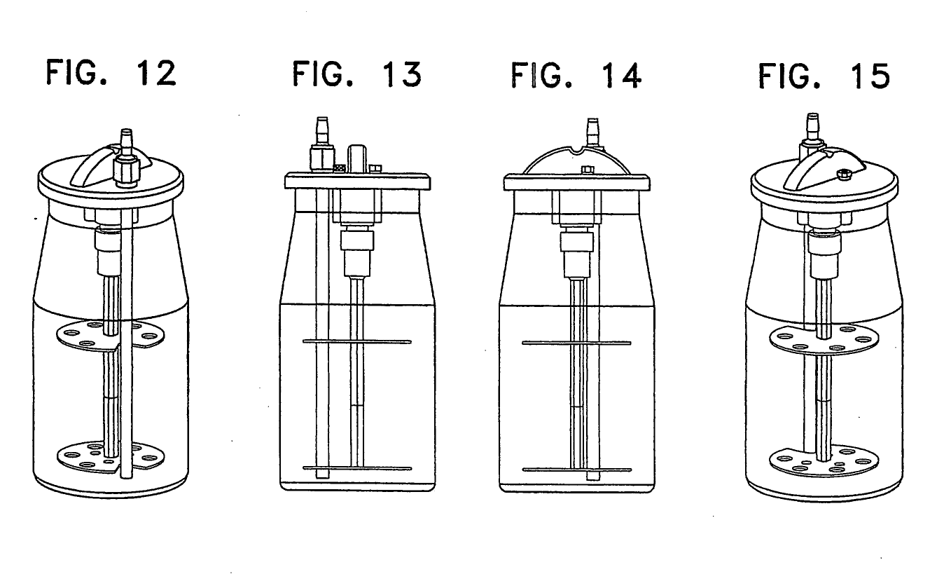

Throughout the sensing and pumping operations summarized in FIG. 9, the vaccine particles are kept uniformly distributed within an appropriate diluent by the vaccine container 80 and agitation mechanism 14, shown in various views as assembled in FIGS. 11-15. The agitation mechanism 14 includes an agitation assembly generally designated by the reference numeral 82, and a lid assembly generally designated by the reference numeral 84. The container is further provided with a draw tube assembly generally designated by the reference numeral 86.

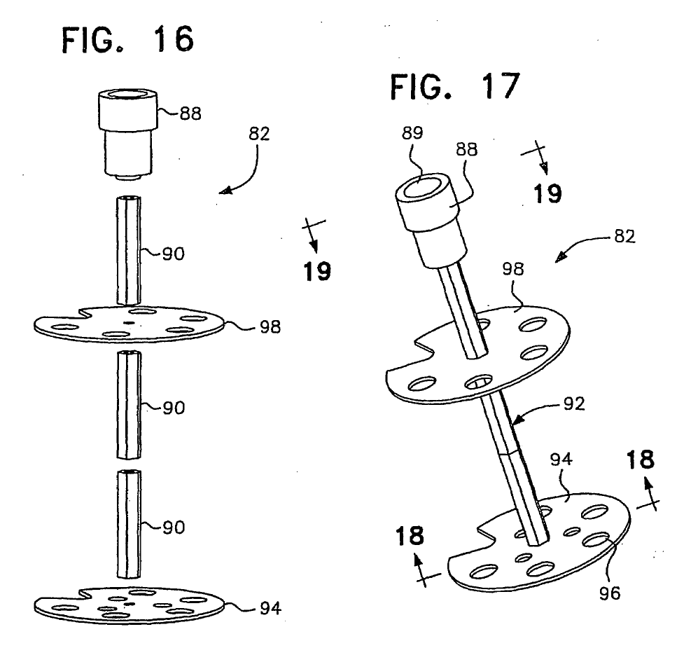

As shown in more detail in FIGS. 16-20, the agitation assembly 82 includes an agitation lower body 88, a plurality of shaft segments 90 forming an agitator shaft generally designated by the reference numeral 92, and a plate or disc 94. The disc 94, which is preferably made of stainless steel, is attached to the bottom of the agitator shaft 92 and perpendicular thereto. A plurality of orifices 96, preferably evenly distributed radially, are provided in the surface of the disc 94. Additional discs 98 may be placed on the agitator shaft 92 if the depth of the vaccine container is sufficient, e.g., is deeper than six inches.

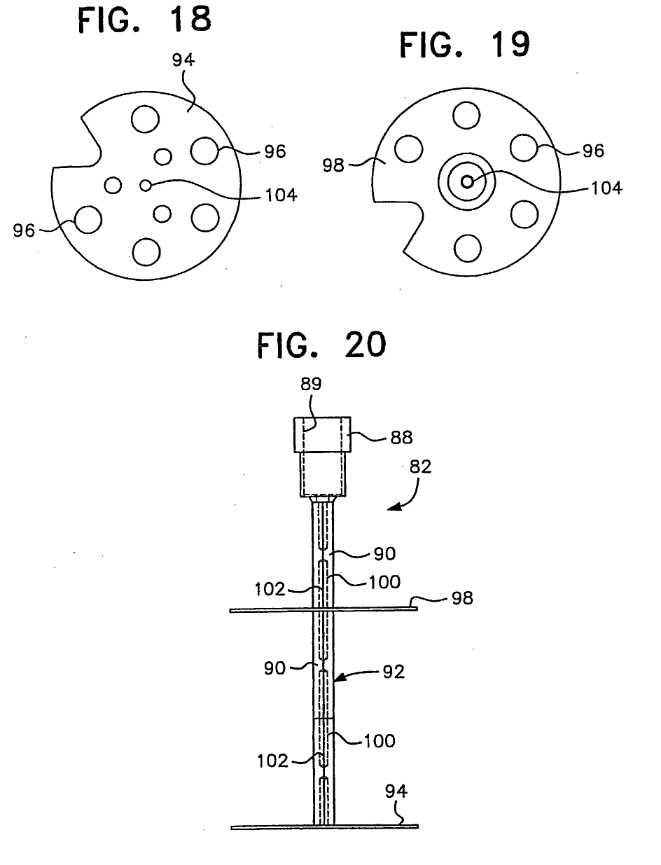

The segments 90 may be solid with the discs welded in place. Alternatively, as shown in FIG. 20, the segments may be internally threaded as at 100 and connected by screws 102 to obtain the desired shaft length. The screws 102 pass through a central aperture 104 in the disc, with the disc being held between male and female threads. The shaft segments are preferably made of stainless steel or, in the threaded alternative, plastic or stainless steel.

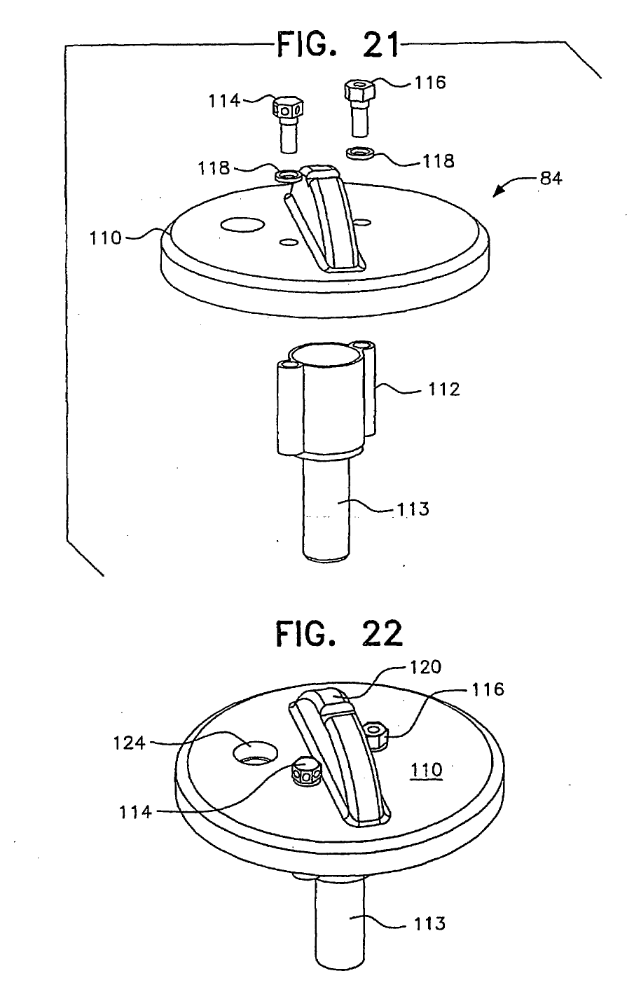

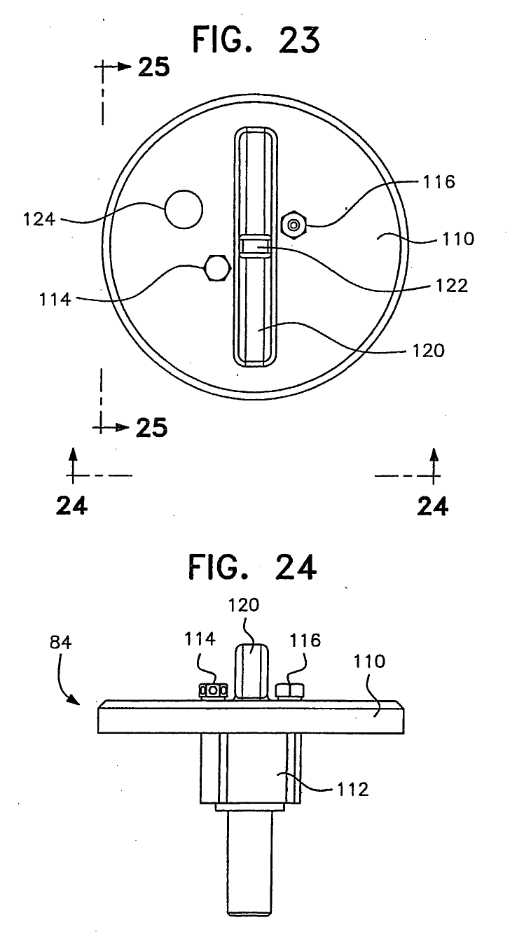

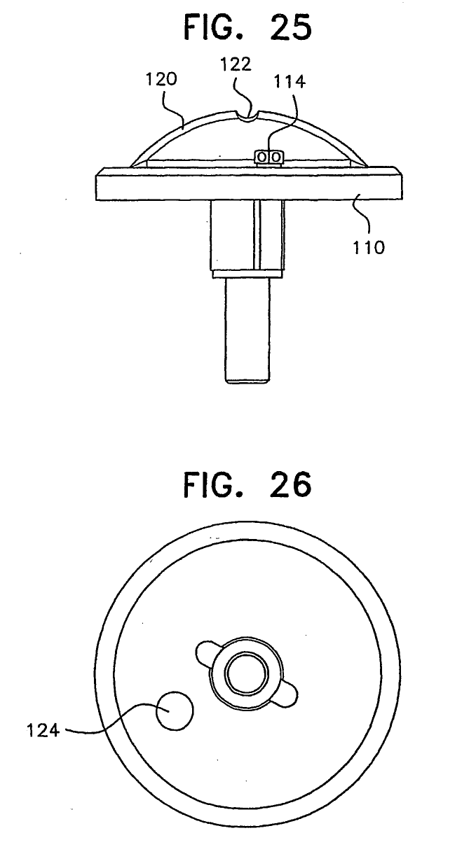

The lid assembly 84 is variously depicted in FIGS. 21-26. As shown, the lid assembly 84 includes a lid 110, an agitator upper body 112, and a power source 15 (FIG. 2) held under the lid by an exhaust bolt 114 and an intake bolt 116, each having a corresponding washer 118. The upper surface of the lid 110 includes a raised portion 120 with a notch 122 for a spring clipping mechanism, such as that used on jelly jars. In addition, an aperture 124 is provided in the lid 110 for passage of the draw tube assembly 86 which includes the draw tube 126 secured to the lid 110 by the tubing coupling 128. The hose 16 fits over the tubing coupling to provide a liquid-tight transfer of vaccine from the container 80, through the draw tube 126 and hose 16, to the spray alignment system 34 and corresponding nozzles 32.

Vaccine agitation is created by use of the power source 15 which is capable of producing a generally vertical reciprocating motion. The power source may be a pneumatic cylinder, an electric solenoid, an electric or pneumatic motor, etc. In alternative to being mounted under the lid, the power source 15 may be mounted on the top of the vaccine container 80 or even separate from the container 80.

In the embodiment shown, the agitator upper body 112 of the lid assembly 84 includes a lower extension 113 that fits within the bore 89 of the agitator lower body 88, as shown by the dotted lines in FIG. 20. In this nested configuration, the upper and lower bodies 112, 88 form a magnetic coupling that connects the power source in the lid assembly 84 to the shaft 92 and agitator discs 94, 98 of the agitator assembly 82. While other coupling mechanisms may be employed, the magnetic coupling allows for easy disassembly and cleanup, with no tools being necessary to separate the coupled components.

The agitator shaft 92 is attached to the power source so as to be capable of reaching a position near the bottom of the vaccine container when in the extended mode. The vertically reciprocating motion of extending and retracting the shaft and the perpendicular attached discs 94, 98 produces the necessary agitation to maintain the vaccine suspended evenly in the diluent.

As the discs 94, 98 begin a down stroke, the vaccine is forced through the disc orifices 96 and the open area that exists between the vaccine container's inner diameter 81 and disc's outer diameter 95. This downward stroke creates pressure on the vaccine and, as it passes through the disc orifices, velocity increases. The same condition occurs on the upward stroke. This agitation, which can be effectively produced by as little as about 0.250 inches of reciprocating motion, ensures that the vaccine cells are evenly suspended throughout the diluent.

Operation of the vaccine spraying apparatus as herein described is generally monitored or observed by an operator, at least on a periodic basis. To assist the operator and reduce the number of operational characteristics to be observed, the spraying station may be equipped with an alarm mechanism that provides a visual and/or audible signal when the vaccine remaining in the container has reached a minimum level. Such a mechanism, which may be embodied using a light and/or buzzer device, is preferably mounted on the frame of the spraying station and hard-wired to a sensing mechanism associated with the container. Alternatively, the alarm mechanism may be located remotely from the spraying station, with a hard-wired or wireless connection thereto, to notify the operator when he or she is in another location that the vaccine container is empty or nearly empty.

The spraying station may further be constructed to include two spray alignment systems 34 with associated nozzles 32, each spray alignment system being coupled to a respective one of two containers 80 in order to apply two types of vaccines. The hoods 35 of the two spray alignment systems 34 would be oriented so as to be substantially parallel with one another, each extending transversely to the conveyor. With this arrangement, the first and second vaccines are applied in sequence as the underlying tray of chicks moves along the conveyor beneath the two respective spray alignment systems 34. This not only increases the efficiency of the vaccine spraying apparatus but also reduces the number of times that the chicks must be passed in trays along the conveyor.

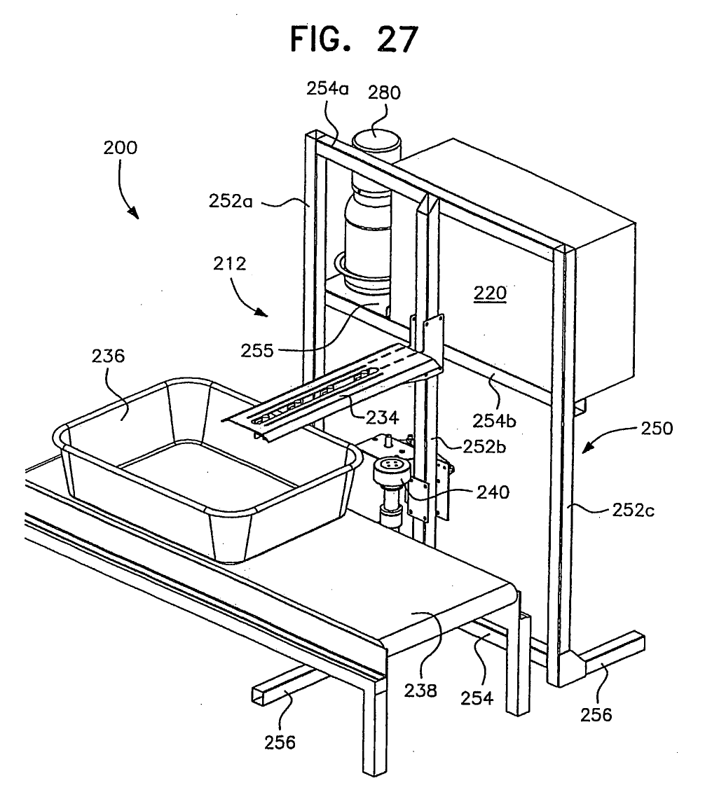

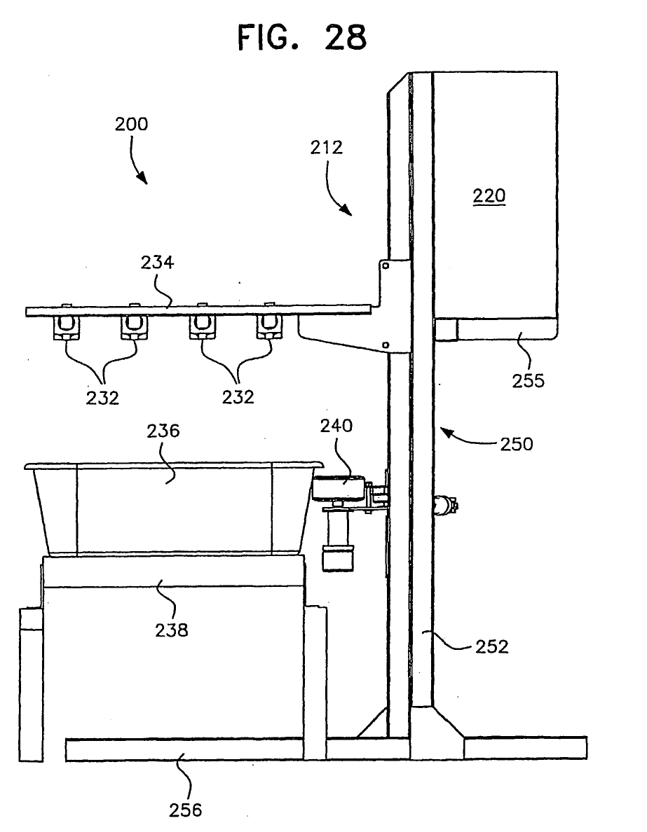

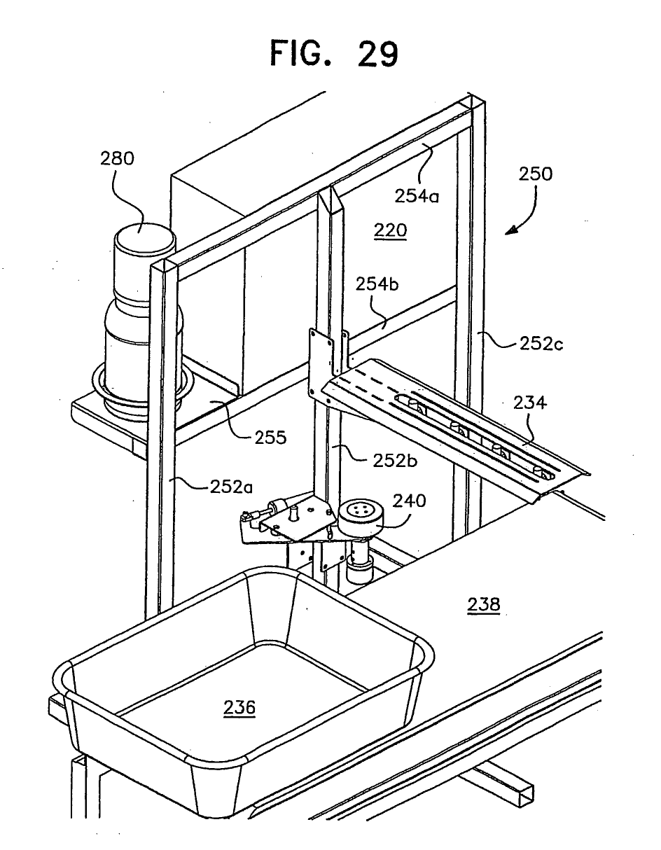

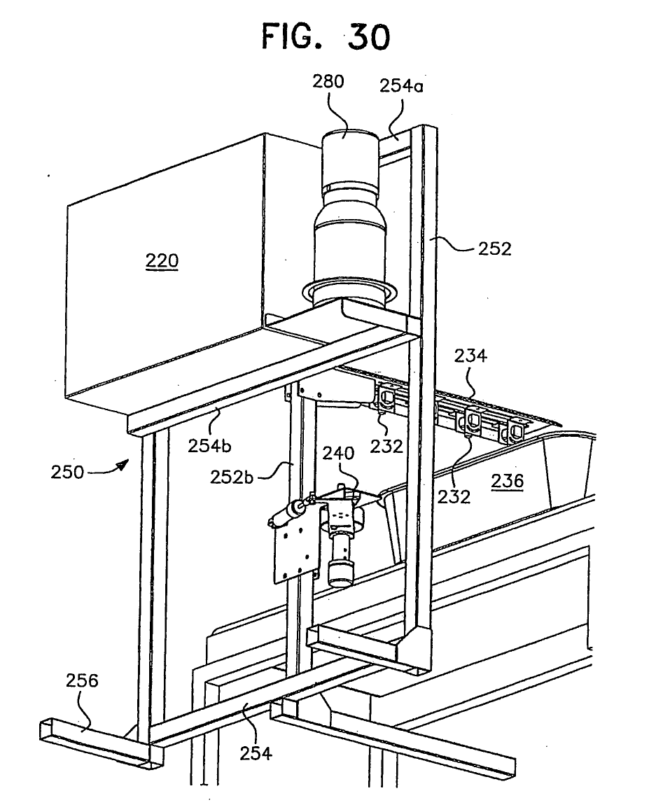

According to a further embodiment of the support framework for a spraying apparatus in accordance with the present invention, components of a vaccine spray apparatus, generally designated by the reference numeral 200, may be constructed as shown in FIG. 27. The apparatus 200 includes a spraying station generally designated by the reference numeral 212, and a vaccine container 280 which includes a vaccine agitation mechanism (not shown) of a type like that already described in, connection with FIG. 1. The operation of the vaccine spray apparatus 200 is consistent with that of the spray apparatus 10 and so will not be repeated here except to identify the components shown in FIGS. 27-30.

The container 280 is coupled to the station 212 by a hose or other connecting element (not shown) which draws vaccine from the top of the vaccine agitation mechanism through the action of a pulse-activated volumetric pump contained within control box 220 as part of a digital control system. The pump is used to measure and dispense the vaccine through a supply hose (not shown) which directs vaccine through sub-lines (not shown) to the nozzles 232 in the station 212 for use in spray application of the vaccine. The nozzles are mounted in a spray alignment system 234 and direct the vaccine spray downward toward a tray 236 moving on a conveyor segment 238 which, as shown, is just a portion of a larger conveyor mechanism with which the spraying station is designed to operate. The spraying station 212 includes a tracking device 240 that senses the presence and movement/speed of the tray 236 on the conveyor 238.

The station 212 is built upon a frame generally designated by the reference numeral 250. The frame 250 has spaced vertical members 252 with adjoining horizontal members 254. According to the preferred embodiment shown, a central vertical member 252b positioned between outer vertical members 252a, 252c supports the spray alignment system 234 and the tracking device 240, both of which are mounted thereon.

The control box 220 is secured to upper and intermediary horizontal members 254a, 254b and to the central vertical member 252b and at least one of the outer vertical members 252a, 252c. In the preferred embodiment shown, the outer vertical member 252a is spaced from one end of the control box and is fitted with a shelf 255. The container 280 is supported on the shelf 255 as shown.

The frame 250 is supported by base members 256 that extend horizontally so as to be perpendicular to both the vertical members 252 and the horizontal members 254 and support the frame in a generally vertical orientation.

The foregoing descriptions and drawings should be considered as illustrative only of the principles of the invention. The invention may be configured in a variety of shapes and sizes and is not limited by the dimensions of the preferred embodiment. Hence, it is not desired to limit the invention to the specific examples disclosed or the exact construction and operation shown and described. Rather, all suitable modifications and equivalents may be resorted to, falling within the scope of the invention.

1. A vaccine spraying apparatus for vaccinating chicks, comprising:
a vaccine container with an agitation mechanism for holding and thoroughly mixing vaccine and diluent through controlled agitation; and
a vaccine spraying station cooperating with a moving conveyor, said spraying station including a plurality of spray nozzles mounted over the conveyor and a pump that draws vaccine from the container for dispensing the mixed vaccine to said spray nozzles, said spray nozzles directing the mixed vaccine onto a plurality of chicks passing along the conveyor.

2. The vaccine spraying apparatus as set forth in claim 1, further comprising:
a control unit for directing the pump to dispense a desired volume of vaccine; and
a tracking device mounted on the spraying station so as to be adjacent the conveyor, said tracking device being configured to sense a position and speed of the chicks and to convey corresponding position and speed data to said control unit, said control unit configured to direct said pump to dispense the desired volume according to said data.

3. The vaccine spraying apparatus as set forth in claim 2, wherein said pump is a pulse-activated volumetric pump.

4. The vaccine spraying apparatus as set forth in claim 2, wherein said control unit includes a digital micro-controller.

5. The vaccine spraying apparatus as set forth in claim 4, wherein said micro-controller is programmable, being configured to receive at least one of a plurality of memory chips respectively configured to apply one of a plurality of different spray patterns.

6. The vaccine spraying apparatus as set forth in claim 1, wherein said spray nozzles are self-cleaning and are positioned approximately eight inches above said chicks moving on said conveyor.

7. The vaccine spraying apparatus as set forth in claim 6, wherein said spray nozzles are configured such that the vaccine flows through nozzle openings therein as a stream, said stream being broken to form desired droplet size and pattern by a low pressure air stream flowing below said nozzle openings.

8. The vaccine spraying apparatus as set forth in claim 7, wherein said spray nozzles are connected to said vaccine container by at least one hose.

9. The vaccine spraying apparatus as set forth in claim 8, wherein said vaccine container further includes a draw tube assembly for directing vaccine out of the container to said spray nozzles.

10. The vaccine spraying apparatus as set forth in claim 9, wherein said agitation mechanism includes a shaft fitted with at least one disc having a plurality of apertures therethrough, and a lid assembly fitted to said container and having a power source for communicating with said shaft and disc to produce a vertical reciprocating motion thereof.

11. The vaccine spraying apparatus as set forth in claim 10, wherein said draw tube assembly extends within said container generally parallel with said shaft and has a portion that projects through an aperture in said lid assembly for connection to said spray nozzles via a hose.

12. The vaccine spraying apparatus as set forth in claim 10, wherein said shaft is fitted with two discs, one disc being adjacent a bottom of said container and the other disc positioned approximately midway along said shaft, both of said discs having apertures therethrough and being generally perpendicular to and movable with said shaft.

13. The vaccine spraying apparatus as set forth in claim 12, wherein each of said discs includes a cutout for accommodating said draw tube assembly.

14. The vaccine spraying apparatus as set forth in claim 10, wherein said lid assembly includes a lid, an agitator upper body and an agitator lower body, said agitator lower body being coupled to said shaft, said agitator upper body being coupled to a lower surface of said lid and engaging with said agitator lower body.

15. The vaccine spraying apparatus as set forth in claim 14, wherein an extending portion of said agitator upper body nests within said agitator lower body to form a magnetic coupling.

16. The vaccine spraying apparatus as set forth in claim 1, wherein the chicks are held in trays which are positioned on said conveyor.

17. A spraying station for spraying dispersed liquid vaccine onto chicks moving on a conveyor, said station comprising:
a spray alignment system positioned over a conveyor and including a plurality of spray nozzles mounted in a hood so as to direct a stream of vaccine downward toward chicks on said conveyor;
a pair of conduits running longitudinally along a length of said hood beneath said spray nozzles, one conduit being on either side thereof and both conduits having apertures therein to direct air toward an output of said spray nozzles, said apertures of said pair of conduits being aligned so as to direct air from opposing sides to the output of each of said spray nozzles; and
a programmable air regulator for generating adjustable low pressure air streams within said pair of conduits, said air streams dispersing the vaccine stream output by said spray nozzles to achieve a desired droplet size and pattern of the vaccine prior to contact thereof with the chicks.

18. The spraying station as set forth in claim 17, wherein said spray nozzles are self-cleaning and are positioned approximately eight inches above said chicks moving on said conveyor.

19. A vaccine mixing apparatus for use with a spraying station for vaccinating chicks, comprising:
a vaccine container for holding vaccine and diluent to be mixed and dispersed on the chicks;
a draw tube assembly extending into said container for directing mixed vaccine out of the container to an associated spraying station; and
an agitation mechanism including an agitation assembly positioned within said container and having a shaft fitted with at least one disc having a plurality of apertures therethrough, and a lid assembly fitted to said container and having an associated power source for communicating with said agitation assembly to produce a vertical reciprocating motion of said shaft and disc that mixes said vaccine and said diluent.

20. The vaccine mixing apparatus as set forth in claim 19, wherein said shaft is fitted with two discs, one disc being adjacent a bottom of said container and the other disc positioned approximately midway along said shaft, both of said discs having apertures therethrough and being generally perpendicular to and movable with said shaft.

21. The vaccine mixing apparatus as set forth in claim 20, wherein said lid assembly includes a lid, an agitator upper body and an agitator lower body, said agitator lower body being coupled to said shaft, said agitator upper body being coupled to a lower surface of said lid and engaging with said agitator lower body to form a magnetic coupling therewith.
